(19) United States
(12) Patent Application Publication
(10) Pub. No.: US 2023/0198184 A1
(43) Pub. Date: Jun. 22, 2023

(54) ELECTRIC CONNECTOR

(71) Applicant: GIGA-BYTE TECHNOLOGY CO., LTD., New Taipei City (TW)

(72) Inventors: Chih-Ming LAI, New Taipei City (TW); Yung-Shun KAO, New Taipei City (TW)

(73) Assignee: GIGA-BYTE TECHNOLOGY CO., LTD., New Taipei City (TW)

(21) Appl. No.: 17/830,203

(22) Filed: Jun. 1, 2022

(30) Foreign Application Priority Data
Dec. 17, 2021 (TW) 110147318

(51) Int. Cl. H01R 13/11

(52) U.S. Cl. CPC H01R 13/112

(57) ABSTRACT

An electric connector includes a housing, at least one terminal, and at least two elastic members, the housing has at least one through hole, the at least one terminal is located at the at least one through hole and includes two arm parts, the at least two elastic members are clamped by the two arm parts and an inner wall forming the at least one through hole.

### CROSS REFERENCE TO RELATED APPLICATIONS

This non-provisional application claims priority under 35 U.S.C. § 119(a) on Patent Application No(s). 110147318 filed in Taiwan (R.O.C.) on December 17th, 2021, the entire contents of which are hereby incorporated by reference.

### TECHNICAL FIELD

The disclosure relates to an electric connector.

### BACKGROUND

Electric connector generally means an input/output interface widely used to realize signal transmission among different electronic devices. A typical electric connector may include a housing and a set of terminals held in the housing, and the housing has a plurality of through holes arranged in a specific array and respectively for accommodating the terminals therein. These through holes are configured for receiving pins of another electric connector so as to allow the pins to insert into the through holes and to be inserted into the distal ends of the terminals, thereby realizing the electrical connection between the pins and the terminals.

However, due to manufacturing tolerance or how the electric connector is assembled, the conventional electric connectors are often found that the terminals are displaced from the predetermined positions, which makes the pins difficult to correctly connect with the terminals. Also, the displacement of terminals easily causes the pins to hit the terminals at an unwanted angle and thus displacing the terminals even more. As a result, some or all of the pins are unable to correctly connect to the terminals and thereby resulting in a poor contact or connection failure. In some cases, the displaced terminals might be forced to move backward when being hit or pushed by the pins. Other than the above problems, the conventional terminals tend to be displaced over time since holding the pins for a long time will cause elastic fatigue.

### SUMMARY

Accordingly, one aspect of the disclosure is to provide an electric connector capable of solving the problem that the terminals of conventional electric connectors are easily displaced from their predetermined positions.

One embodiment of the disclosure provides an electric connector includes a housing, at least one terminal, and at least two elastic members, the housing has at least one through hole, the at least one terminal is located at the at least one through hole and includes two arm parts, the at least two elastic members are clamped by the two arm parts and an inner wall forming the at least one through hole.

According to the electric connector as discussed in the above embodiments of the disclosure, since the elastic members are arranged at two opposite sides of the arm parts of the terminal and clamped by the arm parts and the inner wall of the through hole, the elastic members can constantly provide pressure to force the arm parts to come closer to each other. As such, the elastic members are able to correct or ensure the positions of the arm parts before the insertion of pin, thereby preventing any unwanted displacement of the arm parts of the terminal due to manufacturing tolerance and ensuring that the pin will be correctly inserted into the through hole of the terminal.

Also, due to the pressure that the elastic members apply on the arm parts, the terminal is kept stably contacting with the pin, such that the electrical connection is secured over time. Further, by the elastic members, the arm parts still can return to their original positions after being used for clamping the pin for a long time, thereby effectively preventing problems caused by elastic fatigue of the arm parts. As discussed, since the elastic members are able to make the arm parts return to their predetermined positions after or before pin is inserted into the terminal, the insertion of the pin is prevented from hitting or incorrectly pushing the terminal, thereby preventing the terminal from being moved backward by the push of the pin.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is a partially enlarged perspective view of an electric connector according to one embodiment of the disclosure;

FIG. 2 is a partially enlarged cross-sectional view of the electric connector taken along line 2-2 in FIG. 1;

FIG. 3 is a partially enlarged view of one of the terminals in FIG. 1;

FIG. 4 is a partially enlarged perspective view of one of the terminals in FIG. 1;

FIG. 5 is a partially enlarged cross-sectional view of an electric connector according to another embodiment of the disclosure; and

FIG. 6 is a partially enlarged cross-sectional view of an electric connector according to still another embodiment of the disclosure.

### DETAILED DESCRIPTION

Aspects and advantages of the disclosure will become apparent from the following detailed descriptions with the accompanying drawings. The inclusion of such details provides a thorough understanding of the disclosure sufficient to enable one skilled in the art to practice the described embodiments but it is for the purpose of illustration only and should not be understood to limit the disclosure. On the contrary, it is intended to cover alternatives, modifications, and equivalents as can be included within the spirit and scope of the described embodiments as defined by the appended claims. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features.

It is to be understood that the phraseology and terminology used herein are for the purpose of better understanding the descriptions and should not be regarded as limiting. Unless specified or limited otherwise, the terms “mounted,” “connected,” and variations thereof are used broadly and encompass both direct and indirect mountings and connections. As used herein, the terms “substantially” or “approximately” may describe a slight deviation from a target value, in particular a deviation within the production accuracy and/or within the necessary accuracy, so that an effect as present with the target value is maintained. Unless specified or limited otherwise, the phrase “at least one” as used herein may mean that the quantity of the described element or component is one or more than one but does not necessarily mean that the quantity is only one. The term “and/or” may be used herein to indicate that either or both of two stated possibilities.

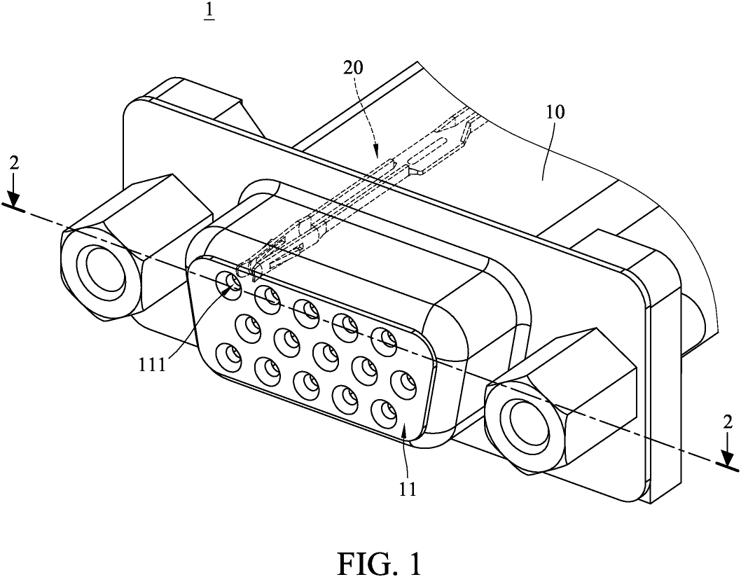

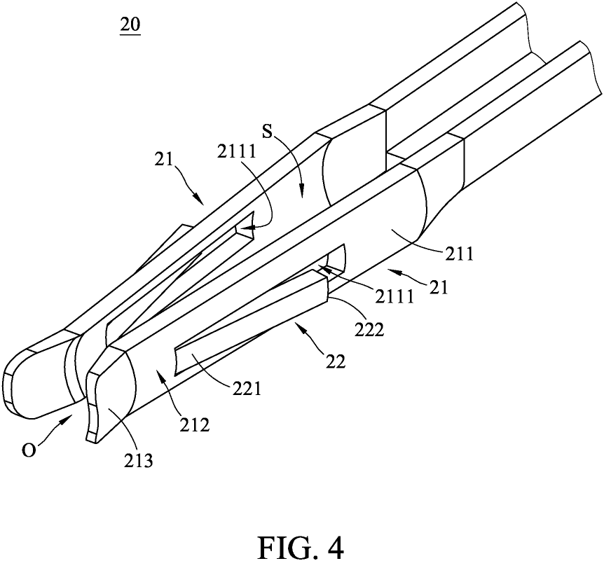

Firstly, referring to FIGS. 1-4, one embodiment of the disclosure provides an electric connector 1, the electric connector 1 may include a housing 10 and at least one terminal 20. The housing 10 may be served as a housing or part of a housing that can accommodate or hold the terminal 20 in place. The housing 10 may be made of any suitable material and may be shaped or sized as required. Optionally, the housing 10 may have a mating part 11, the mating part 11 may be a part on the housing 10 configured to physically fit another electric connector of another housing (not shown). The mating part 11 may be in a size and shape that facilitate the installation of the electric connector 1 to another electric connector of another device or structure.

Further, the housing 10 may have at least one through hole 111. The through hole 111 penetrates through the mating part 11 and is configured for accommodating at least part of the terminal 20. In one embodiment, the electric connector 1 may include a plurality through holes 111 for accommodating the same number of terminals 20, and the terminals 20 are exposed from the through holes 111. It is noted that the numbers and arrangements of the through holes 111 and the terminals 20 may be changed as required and are not intended to limit the disclosure.

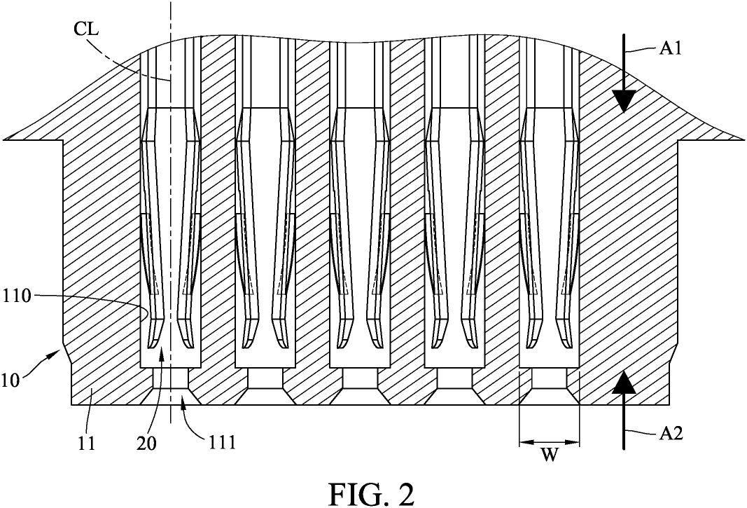

In more detail, each through hole 111 is defined by an inner wall 110 of the mating part 11 of the housing 10. As shown in FIG. 2, each through hole 111 may have a central line CL, the central line CL is an imaginary reference line that penetrates through the through hole 111 with a fixed radial distance with respect to the inner wall 110, in other words, the central line CL is substantially parallel to the extension direction of the through hole 111. Herein, the area of the through hole 111 that is used to accommodate the terminal 20 has a width W, and the width W is in a size suitable for making the terminal 20 contact or press against the inner wall 110.

The terminal 20 is served to electrically connect to a pin (not shown) of another connector; in specific, the through hole 111 is allowed a suitable pin (not shown) to insert therethrough to contact the terminal 20 therein. The terminal 20 is made of any suitable electrically conductive material. In one embodiment, the terminals 20 may be installed into the side of the mating part 10 opposite to the openings of the through holes 111 from the direction indicated by arrow A1, and the terminals 20 are able to receive the pin (not shown) that are inserted into the through holes 111 from the direction indicated by arrow A2. As discussed, during the insertion of the pin of another electric connector into the through hole 111 to electrically connect to the terminal 20, the pin may apply force in the direction the same as indicated by arrow A2 to the terminal 20. Generally, the pin is expected to interact with the terminal 20 in a way of being inserted into the through hole 111 along the central line CL of the through hole 111. To this end, two opposite sides of each terminal 20 may have an elastically restoring arrangement to prevent the terminal 20 from being displaced due to manufacturing tolerance before the insertion of the pin into the through hole 111. The relevant details are given hereinafter.

In this embodiment, each terminal 20 may include at least two arm parts 21, the arm parts 21 are parts of the terminal 20 spaced apart by a proper distance suitable for clamping the pin being disposed into the through hole 111. The terminal 20 is able to electrically connect to the pin via the arm parts 21. Specifically, the terminal 20 has an insertion hole S and a receiving opening O at an end of the insertion hole S. The insertion hole S is defined by the arm parts 21 and is configured to accommodate the pin. The receiving opening O is an entrance allowing the pin to be inserted into the insertion hole S.

In more detail, each arm part 21 may include an extension portion 211, a neck portion 212 and a lip portion 213. The neck portion 212 is connected to and located between the extension portion 211 and the lip portion 213. The extension portion 211 is the part of the arm part 21 substantially extending along the central line CL of the through hole 111. The neck portion 212 is the part of the arm part 21 connected to the extension portion 211 and is at an angle to the extension portion 211 (in other words, the neck portion 212 is inclined with respect to the extension portion 211). As shown, the neck portions 212 of each pair of the arm parts 21 are inclined with respect to the central line CL of the through hole 111 and a distance therebetween decreases in a direction away from the extension portions 211. Such an arrangement of the neck portions 212 is able to clamp the pin when the pin is disposed in the insertion hole S, ensuring that the arm parts 21 are electrically connected to the pin. The lip portion 213 is the part of the arm part 21 connected to the neck portion 212 and is at an angle to the neck portion 212 (in other words, the lip portion 213 is inclined with respect to the neck portion 212). The receiving opening O is defined by the lip portions. As shown, the lip portions 213 of each pair of the arm parts 21 are inclined with respect to the central line CL of the through hole 111 and a distance therebetween increases in a direction away from the extension portions 211. Such an arrangement of the lip portions 213 facilitates the insertion of the pin into the insertion hole S.

In addition, in this embodiment, the electric connector 1 may further include a plurality of elastic members 22 respectively arranged at two opposite sides of each terminal 20. The elastic members 22 are clamped by the terminals 20 and inner walls 110 of the through holes 111. Specifically, the elastic members 22 are respectively located at two opposite sides of each pair of the arm parts 21. In this embodiment, the elastic members 22 are integrally formed with the arm parts 21. For example, each elastic member 22 is a bending outwards structure integrally formed with the arm part 21, thus the elastic member 22 leaves a cutout 2111 at the extension portion 211; in other words, the elastic members 22 are respectively located at cutouts 2111 of the arm parts 21. Understandably, the cutouts 2111 are able to receive at least part of the elastic members 22 when the elastic members 22 are deformed.

The elastic members 22 extend outwards from the arm parts 21 and have a suitable elasticity to respond to force coming from the arm parts 21, such that the arm parts 21 can be elastically returned to their predetermined positions by the elastic members 22. In detail, as shown, each elastic member 22 may have a fixed end 221 and a free end 222, the fixed end 221 is directly connected to the arm part 21, and the free end 222 is located opposite to the fixed end 221. The free ends 222 of the elastic members 22 are movable with respect to the arm part 21 (as the directions indicated by arrow A3 and arrow A3′).

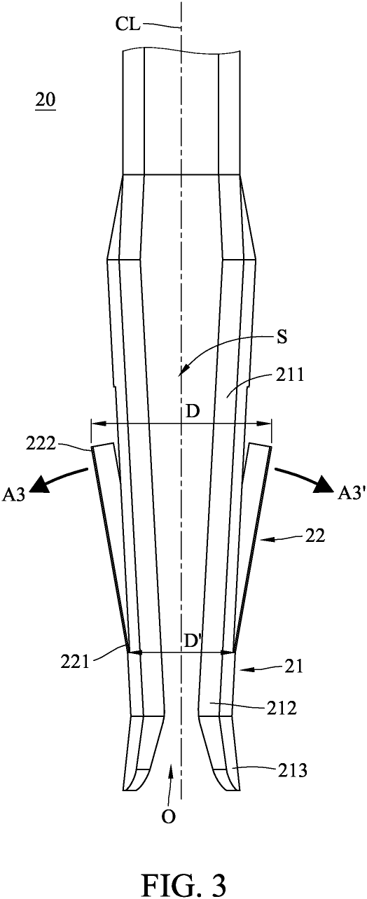

When there is no external force applied to the elastic members 22, the elastic members 22 are in a released status as shown in FIG. 3. In FIG. 3, a distance D between the free ends 222 of the elastic members 22 is greater than a distance D′ between the fixed ends 221 of the elastic members 22. To ensure that the elastic members 22 can provide a sufficient pressure to restore the positions of the arm parts 21, the distance D between the free ends 222 of the elastic members 22 is also greater than the width W of the area of the through hole 111 that is used to accommodate the terminal 20. In such an arrangement, when the terminal 20 is disposed in the through hole 111, the elastic members 22 are deformed by the inner wall 110 and therefore stores potential energy that can be used to force the arm parts 21 to incline towards each other.

Such a pressure provided by the elastic members 22 is able to correct or ensure the positions of the arm parts 21 before the insertion of pin into the terminal 20. Specifically, the pressure that the elastic members 22 press against the inner wall 110 can make the arm parts 21 stay in predetermined positions with respect to the central line CL of the through hole 111. Thus, the elastic members 22 are able to ensure the distance between the arm parts 21 and the central line CL of the through hole 111 as required, such that the arm parts 21 are prevented from being displaced or off place due to manufacturing tolerance. As a result, the pin is ensured to be inserted into the through hole 111 along the central line CL so as to be correctly entering the insertion hole S of the terminal 20 from the receiving opening O. In addition, since the elastic members 22 can constantly force the arm parts 21 to press against the pin, the electrical connection between the terminal 20 and the pin is secured. Further, by the elastic members 22, the arm parts 21 still can return to their original positions after being used for clamping the pin for a long time, such that the arm parts 21 are prevented from displaced from their predetermined positions due to elastic fatigue thereof. As discussed, since the elastic members 22 are able to make the arm parts 22 return to their predetermined positions after or before pin is inserted into the terminal 20, the insertion of the pin is prevented from hitting or incorrectly pushing the terminal 20, thereby preventing the terminal 20 from being moved backwards by the push of the pin.

Each elastic member 22 opens towards a direction away from the receiving opening O, thus the free ends 222 of the elastic members 22 are able to press against the inner wall 110 of the through hole 111 during the insertion of the pin and therefore help resist the push of the pin in a specific direction (as indicated by arrow A2) applied on the arm parts 21. This helps prevent the terminal 20 from being moved backwards by the insertion of the pin.

The previous embodiments are exemplary but not intended to limit the disclosure. Without departing the spirit of providing elastically restoring arrangements at two opposite sides of the terminal as discussed above, the electric connector may be further modified as required.

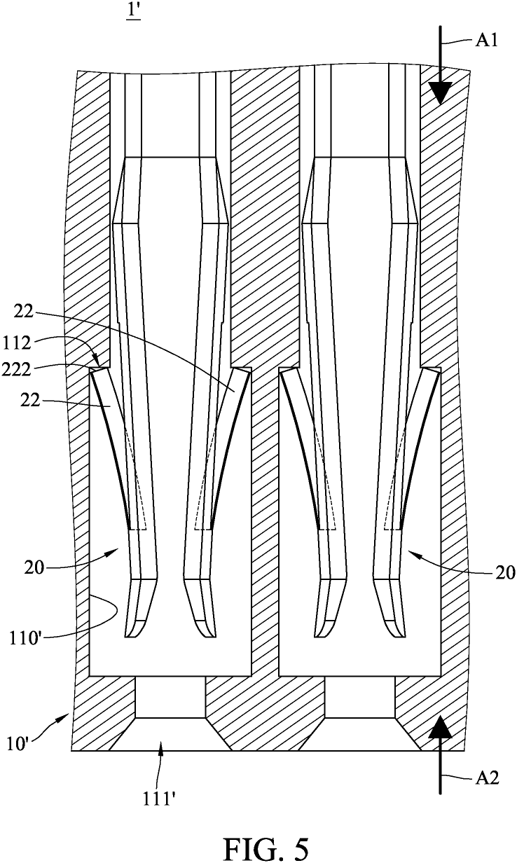

For example, please refer to FIG. 5, an electric connector 1′ is provided, where the same reference numbers denote the same component or structure. The main difference between the electric connector 1′ and the electric connector 1 is that a housing 10′ of the electric connector 1 may have inner walls 110′, and the inner walls 110 form through holes 111′ with steps 112. In specific, the inner wall 110′ may have at least two steps 112 at one through hole 111′, the steps 112 do not affect the installation of the terminal 20 from the side of the electric connector 1′ opposite to the opening of the through hole 111′ (as indicated by arrow A1). When the terminal 20 is installed in the through hole 111′, the free ends 222 of the elastic members 22 can press against the steps 112; in other words, when the terminal 20 is installed in place, the steps 112 block the free ends 222 of the elastic members 22 so as to stop the terminal 20 from moving in a direction opposite to the installation direction of the terminal 20. As such, the position of the terminal 20 is secured and is prevented from being moved backwards by external force. For example, when the pin is inserted into the through hole 111′ to cause pressure in the same direction as indicated by arrow A2 to the terminal 20, the steps 112 stop the free ends 222 from moving in a direction as indicated by arrow A2 so as to secure the position of the terminal 20.

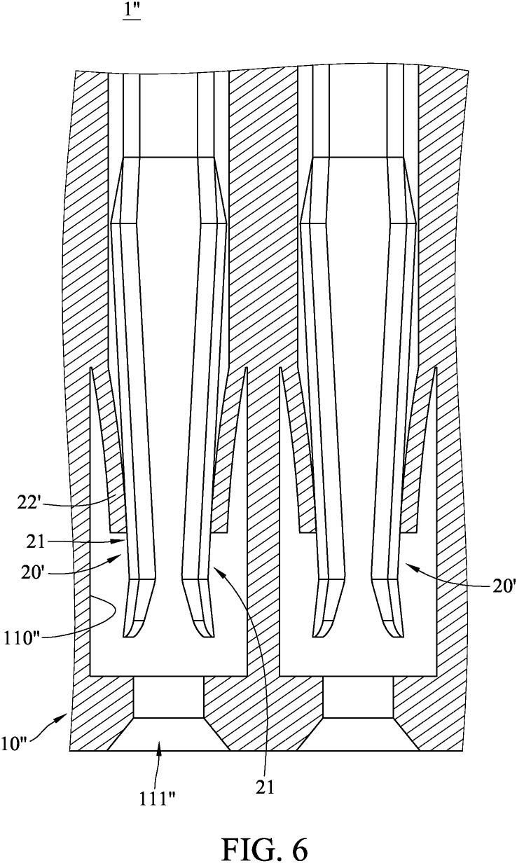

Please refer to FIG. 6, an electric connector 1″ is provided, where the same reference numbers denote the same component or structure. The main difference between the electric connector 1″ and the electric connector 1 is that elastic members 22′ for restoring the position of the arm parts 11 of a terminal 20′ are integrally formed with the inner wall 110″ of a housing 10″. Similarly, since the elastic member 22′ are respectively located at two opposite sides of the arm parts 11, the elastic members 22′ are able to provide force to restore positions of the arm parts 11 and thereby preventing the terminal 20′ from being displaced from their predetermined positions.

According to the electric connector as discussed in the above embodiments of the disclosure, since the elastic members are arranged at two opposite sides of the arm parts of the terminal and clamped by the arm parts and the inner wall of the through hole, the elastic members can constantly provide pressure to force the arm parts to come closer to each other. As such, the elastic members are able to correct or ensure the positions of the arm parts before the insertion of pin, thereby preventing any unwanted displacement of the arm parts of the terminal due to manufacturing tolerance and ensuring that the pin will be correctly inserted into the through hole of the terminal.

Also, due to the pressure that the elastic members apply on the arm parts, the terminal is kept stably contacting with the pin, such that the electrical connection is secured over time. Further, by the elastic members, the arm parts still can return to their original positions after being used for clamping the pin for a long time, thereby effectively preventing problems caused by elastic fatigue of the arm parts. As discussed, since the elastic members are able to make the arm parts return to their predetermined positions after or before pin is inserted into the terminal, the insertion of the pin is prevented from hitting or incorrectly pushing the terminal, thereby preventing the terminal from being moved inward by the push of the pin.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An electric connector comprising:
a housing having at least one through hole;
at least one terminal located at the at least one through hole and comprising two arm parts; and
at least two elastic members clamped by the two arm parts and an inner wall forming the at least one through hole.

2. The electric connector according to claim 1, wherein the at least two elastic members are respectively integrally formed with the two arm parts.

3. The electric connector according to claim 2, wherein the two arm parts each have a cutout, the at least two elastic members are respectively located at the cutouts of the two arm parts, the cutouts are configured for respectively accommodating at least part of the at least two elastic members when the at least two elastic members are deformed.

4. The electric connector according to claim 1, wherein the two arm parts define a receiving opening therebetween, the at least two elastic members each have a fixed end directly connected to one of the two arm parts and a free end opposite to the fixed end, a distance between the free ends of the at least two elastic members is greater than a distance between the fixed ends of the at least two elastic members and is greater than a width of the at least one through hole.

5. The electric connector according to claim 4, wherein the free end of each of the at least two elastic members is located further away from the at least one through hole than the fixed end.

6. The electric connector according to claim 4, wherein each of the two arm parts comprises an extension portion, a lip portion, and a neck portion located between and connected to the extension portion and the lip portion; in the two arm parts, the neck portions are inclined with respect to the extension portions and a distance therebetween decreases in a direction away from the extension portions, the lip portions are inclined with respect to the neck portions and a distance therebetween increases in the direction away from the extension portions so as to define the receiving opening.

7. The electric connector according to claim 6, wherein the at least two elastic members are respectively integrally formed with the extension portions of the two arm parts.

8. The electric connector according to claim 4, wherein the inner wall has a step configured to block the free ends of the at least two elastic members.

9. The electric connector according to claim 1, wherein the at least two elastic members are integrally formed on the inner wall.
